(19) United States
(12) Patent Application Publication
(10) Pub. No.: US 2005/0107072 A1
(43) Pub. Date: May 19, 2005

(54) System and method for mult-directional message delivery for call waiting

(75) Inventors: Sandra Lynn True, St. Charles, IL (US); David S. Benco, Winfield, IL (US); Kevin J. Overend, Elmhurst, IL (US); Baoling S. Sheen, Naperville, IL (US); Kenneth J. Voight, Sugar Grove, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114, US

(73) Assignee: Lucent Technologies Inc.

(21) Appl. No.: 10/712,623

(22) Filed: Nov. 13, 2003

(51) Int. Cl. H04M 11/00

(52) U.S. Cl. 455/414.1; 455/412.1

(57) ABSTRACT

A system and method of message delivery from a wireless calling party terminal using a wireless communications network to a called party terminal for called parties having call waiting. The method includes determining that the called party terminal's line is busy, delivering a “call waiting no answer” message to the calling party terminal, prompting the calling party to leave a message for the called party, and storing the message from the calling party on the wireless communications network for later delivery to the called party terminal.

### BACKGROUND OF THE INVENTION

This invention relates to the art of telecommunications and more particularly to a system and method of message delivery from a wireless calling party terminal using a wireless communications network to a called party terminal having call waiting.

Telecommunications networks, including wireless communications networks, provide call waiting for users who subscribe to this service. A subscriber subscribing to call waiting, referred to herein as the called party, can be alerted to an incoming call from a calling party while already on the line with a third party. Typically, the called party will be alerted to the incoming call by a series of clicks or other audible alerts. The called party can place the third party on hold by pressing a flash or other suitable key and be connected to the calling party making the incoming call. A called party choosing not to answer the incoming call will typically continue to receive the audible alerts until the calling party hangs up. It is desirable to reduce the annoyance of a continuing stream of audible alerts to the called party having call waiting who doesn't wish to answer while still providing some indication that an incoming call is being received.

The calling party will hear a continuous ringing until the called party connects to the incoming call using call waiting or until the calling party hangs up. Thus the calling party must wait for several rings, 4, 5 or more, before they can determine that the called party has call waiting, is already on the line and refusing to pickup the incoming call. It is desirable to provide an improved indication to the calling party that the called party has chosen not to take the incoming call. Further it is desirable to allow the calling party to leave a message-for the called party when the called party does not answer using call waiting.

The present invention contemplates a new and improved system and method that resolves the above-referenced difficulties and others.

### SUMMARY OF THE INVENTION

A system and method of message delivery from a wireless calling party terminal using a wireless communications network to a called party terminal for called parties having call waiting are provided.

In one aspect of the invention, the method includes determining that the called party terminal's line is busy, delivering a “call waiting no answer” message to the calling party terminal, prompting the calling party to leave a message for the called party, and storing the message from the calling party on the wireless communications network for later delivery to the called party terminal. The message can be delivered to the called party when the called party's line is no longer busy.

In another aspect of the invention, the system includes means for determining that the called party terminal's line is busy, means for delivering a “call waiting no answer” message to the calling party terminal, means for prompting the calling party to leave a message for the called party, and means for storing the message from the calling party on the network later delivery to the called party terminal.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a portion of a wireless communications network in accordance with the invention;

FIG. 2 is a flow chart illustrating the invention; and

FIG. 3 is a flow chart illustrating the invention.

### DETAILED DESCRIPTION OF THE PREFERRED EMBODIMENTS

It is to be understood that the specific methods and systems illustrated in the attached drawings and described in the following specification are simply exemplary embodiments of the inventive concepts defined in the appended claims. Therefore, specific examples and characteristics related to the embodiments disclosed herein are not to be considered as limiting, unless the claims expressly state otherwise.

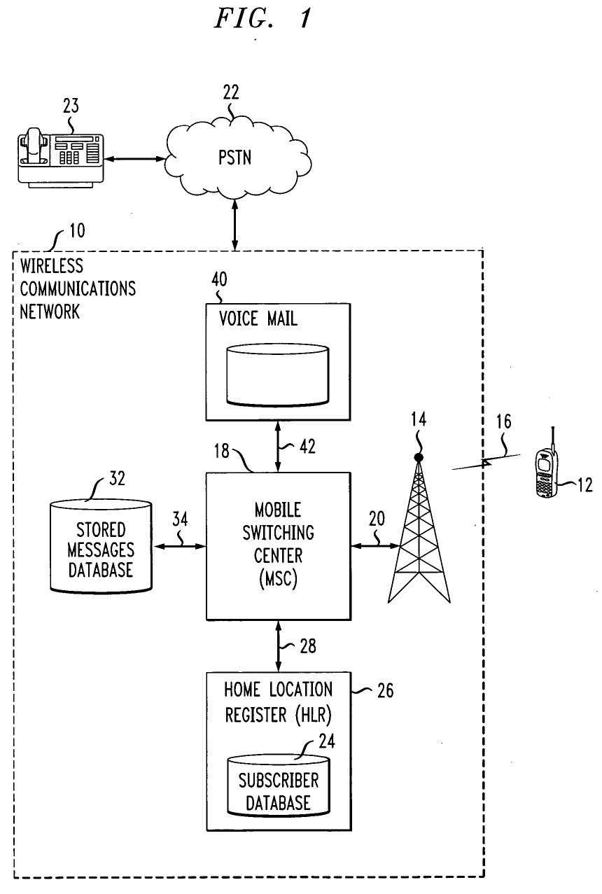

Referring now to the drawings wherein the showings are for purposes of illustrating the preferred embodiments of the invention only and not for purposes of limiting same, FIG. 1 provides a block diagram of a portion of a wireless communications network shown generally at 10. The wireless communications network 10 can be any suitable known wireless communications network including but not limited to CDMA, GSM, etc.

A wireless communications service provider provides the services of the wireless communications network 10 to subscribers. A subscriber can communicate over the wireless communications network 10 using a wireless communications terminal 12. The wireless communications terminal 12, also known as a cellular terminal, can be capable of sending and/or receiving various media such as data, text, special applications, video, etc., as well as voice communications using the wireless communications network 10. Examples of the wireless communications terminal 12 can include, but are not limited to, CDMA, GSM, or any other wireless devices capable of using the wireless communications network 10. For the purposes of this invention, the party using the wireless terminal 12 shall be referred to the calling party and the wireless device 12 shall be referred to as the calling party terminal.

The wireless communications network 10 includes a base station 14 communicating with the calling party terminal 12 over an air interface 16. The wireless communications network 10 also includes a Mobile Switching Center (MSC) 18 communicating with the base station 14 using any suitable known connection 20. The MSC 18 handles the communications of the calling party terminal 12 with the communications network 10 including call set-ups, registration and routing incoming calls to the calling party terminal. In the preferred embodiment, the MSC 18 is a processor-based apparatus with data link interfaces for coupling together other portions of the wireless communications network 10 which are not shown. The MSC 18 can be the calling party terminal's home MSC, or it can be a different MSC in the wireless communications network 10 if the calling party terminal 12 is roaming. The wireless communications network 10 is connected to the Public Switched Telephone Network (PSTN) 22 in a known manner to allow communications between terminals, such as a wireline terminal 23, using the PSTN and wireless terminals 12. For the purposes of explanation of this invention, and by way of example which should not be considered limiting, the wireline terminal 23 shall be referred to as the called party terminal which is used by the called party to communicate over the PSTN 22. The calling party terminal 12 calls the called party terminal 23. The called party terminal 23 can be a wireless terminal communicating using a wireless communications network.

The wireless communications network 10 also includes a subscriber database 24 also known as the subscriber profile. The subscriber database 24 includes stored subscriber profile information, which includes identification of the services the network subscribers subscribe to, such as call waiting as well as the services provided by the invention as described below. The subscriber database 24 can be stored on any suitable node in the wireless communications network 10. By way of example, which should not be considered limiting, the subscriber database 24 can be stored on the Home Location Register (HLR) 26. The HLR 26 is connected to the MSC 18 in a known manner at 28. The HLR 26 can also store information such as user identification, user security information, including network access control information for authentication and authorization, user location information for user registration, etc.

The wireless communications network 10 also includes a database of stored messages 32 awaiting delivery to called parties as described in further detail below. The stored messages database 32 is connected to the MSC 18 using any suitable known connection at 34.

The wireless communications network 10 also includes a voicemail system 40 connected to the MSC 18 in a known manner at 42. The voicemail system 40 stores voicemail messages intended for the called party. The called party can access the voicemail messages via the wireless network 10 in a known manner.

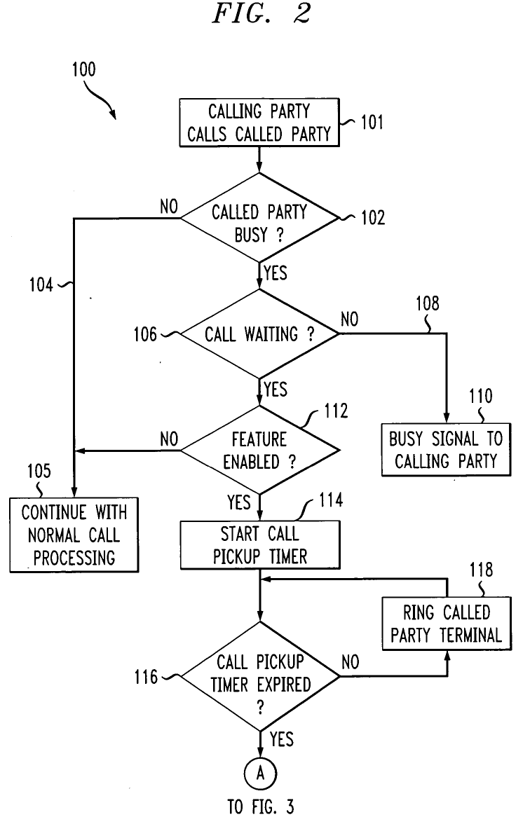

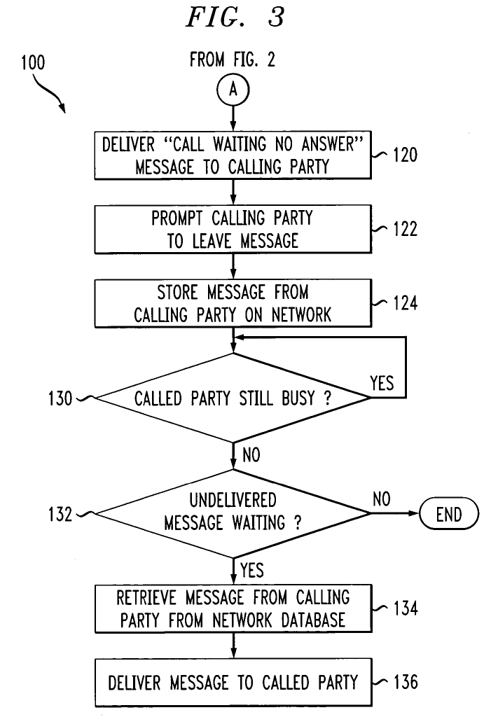

Referring now to FIGS. 2 and 3, a method of message delivery for an incoming call from a wireless calling party terminal using a wireless communications network to a called party terminal, also referred to as the call delivery feature, is shown generally at 100. The method is performed by the MSC 18, or any other suitable one or more processing nodes in the network 10, unless stated otherwise.

The method 100 includes the calling party placing a call to the called party having call waiting at 101. The method also includes determining that the called party terminal is busy at 102. This can be accomplished in any suitable known manner, such as by the MSC 18 receiving the call control messaging commands indicating that the called party terminal is busy which are provided by the wireless communications network 10. If the called party terminal 23 is not busy, as shown by path 104, normal call processing is performed at 105 and the call is routed to the called party terminal. If the called party terminal 23 is busy, that is to say the called party is already on the line, it is determined whether the called party has call waiting at 106. This can be determined by the MSC 18 in a known manner such as by the call control messaging commands received by the MSC from the wireless communications network 10 during call processing. For example, when the called party with call waiting is already on the line, a call control message is sent back to the MSC 18 indicating that a ringback tone and not the busy tone should be sent to calling party terminal 12. If the called party does not have call waiting as shown by path 108, a busy signal is sent to the calling party at 110.

The method 100 also includes determining that the message delivery feature is enabled at 112. If the feature is enabled, a “call waiting no answer” message will be delivered to the calling party, the calling party will be prompted to leave a message for the called party and the message will be stored on the network 10 for later delivery to the called party as will be described in further detail below.

The message delivery feature can be enabled by the called party using any suitable known manner of enabling a calling feature. The service provider can allow each subscriber, in this case the called party, to enable and disable this message delivery feature at their own discretion if they subscribe to the feature. Typically indications that a feature such as the message delivery feature are enabled are provided in the call control messaging. For example, the call control messaging command(s), described above, indicating that the called party's line is busy and that the called party has call waiting can be modified to include a feature activation bit. The feature activation bit can be used indicate to the MSC 18 that the message delivery feature of the invention is activated by the called party at 112. Alternatively, any other suitable manner of determining that the message delivery feature of the invention is activated can be used.

Further, it is contemplated that the calling party can subscribe to the call delivery feature, and therefore enable and disable the feature at their discretion as well. The MSC 18 can determine that the message delivery feature is enable by the calling party by checking the calling party subscriber profile 24 which can store an indicator indicating that the calling party has enabled this feature. The calling party, can subscribe to this feature whether or not they subscribe to call waiting. Further, it is contemplated that the calling party can enable the message delivery feature even though the called party has disabled the feature.

If the message delivery feature is not enabled, normal call processing is continued at 105 and the MSC 18 attempts to connect the calling party to the called party in a known manner.

The method 100 also includes starting a call pickup timer at 114 to provide the called party having call waiting a chance to pickup the incoming call. The call pickup timer can be any suitable predetermined number of rings or it can be any suitable predetermined time period. If the call pickup time has not expired at 116, the MSC 18 rings the called party terminal 23 at 118 to indicate to the called party that they have an incoming call.

The method 100 also includes the MSC 18 delivering a message, referred to herein as a “call waiting no answer” message, to the calling party at 120 after the call timer expires in step 116. The “call waiting no answer” message can be a message pre-recorded by the called party or by a node on the network 10, such as the MSC 18. The message can be stored on the network, such as at the MSC 18 or at any other suitable node. The “call waiting no answer” message tells the calling party that the called party has call waiting, is currently already on the line, and is not answering the calling party's call. Although referred to herein in this manner, it should be noted that the “call waiting no answer” message can be any suitable message as determined by the called party or the service provider.

The calling party is then prompted to leave a message for the called party at 122. The “call waiting no answer” message can prompt the calling party in this manner. Further the “call waiting no answer” message can state that the message the calling party leaves will be delivered to the called party as soon as the called party is off the line. The calling party can then leave their voice message for the called party which is stored on the network 10 at step 124, such as at the message storage database 32, for delivery to the called party.

The method 100 also includes the network, such as the MSC 18, determining that the called party terminal line is no longer busy at 130. This can be accomplished in any suitable known manner, such as for example using call control messaging, such as the called party inter-MSC on-hook message which indicates to the MSC that the called party terminal's line is no longer busy.

The method 100 also includes the MSC 18 determining whether an undelivered message, such as a message stored at database 32, is waiting for the called party at 132. If an undelivered message is waiting, the message is retrieved from the network database 32 at 134 and delivered to the called party at 136. The message can be delivered to the called party's voice mail 40 for later retrieval by the called party The message can be delivered to the called party terminal 23 by ringing the terminal and delivering the stored message when the called party picks up.

The invention provides multi-directional message delivery by sending the calling party a message indicating that the called party has call waiting, is already on the line and is not answering, and providing the calling party the opportunity to leave a message for the called party for later delivery.

It is also to be appreciated that particular elements or components described herein may have their functionality suitably implemented via hardware, software, firmware or a combination thereof Additionally, it is to be appreciated that certain elements described herein as incorporated together may under suitable circumstances be stand alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

1. A method of message delivery from a wireless calling party terminal using a wireless communications network to a called party terminal, wherein the called party terminal has call waiting, the method comprising:
determining that the called party terminal's line is busy;
delivering a “call waiting no answer” message to the calling party terminal;
prompting the calling party to leave a message for the called party; and
storing the message from the calling party on the wireless communications network.

2. The method defined in claim 1 further comprising delivering the message from the calling party terminal to the called party terminal.

3. The method defined in claim 2 further comprising delivering the message from the calling party to the called party terminal when the called party terminal's line is no longer busy.

4. The method defined in claim 3 further comprising:
determining that an undelivered message awaits the called party after the called party terminal's line is no longer busy; and
retrieving the message from the calling party from the network.

5. The method defined in claim 1 wherein the storing step further comprises storing the message from the calling party in the called party's voice mail.

6. The method defined in claim 1 further comprising starting a called party call pickup timer after the step of determining that the called party terminal is busy, wherein the step of delivering the “call waiting no answer” message is performed after the call pickup timer expires.

7. The method defined in claim 6 wherein the call pickup timer includes a predetermined number of rings.

8. The method defined in claim 6 wherein the call pickup timer includes a predetermined time period.

9. The method defined in claim 1 further comprising determining that the called party terminal has call waiting.

10. The method defined in claim 1 further comprising allowing the called party to disable the method of message delivery thereby preventing the delivering, prompting and storing steps.

11. The method defined in claim 1 further comprising allowing the calling party to enable the method of message delivery thereby enabling the delivering, prompting and storing steps.

12. The method defined in claim 11 further comprising allowing the calling party to enable the method of message delivery thereby enabling the delivering, prompting and storing steps even if the calling party does not have call waiting.

13. The method defined in claim 11 wherein the calling party can enable the method of message delivery thereby enabling the delivering, prompting and storing steps even though the called party has disabled the feature.

14. The method defined in claim 1 wherein the called party is using a cellular terminal.

15. The method defined in claim 1 wherein the called party is using a wireline terminal.

16. A method of message delivery for an incoming call from a wireless calling party terminal using a wireless communications network to a called party terminal, wherein the called party terminal has call waiting, the method comprising:
storing a message from the calling party on the wireless communications network when the called party terminal is connected to a third party; and
delivering the stored message from the calling party to the called party once the called party terminal's line is no longer connected to the third party.

17. A system for message delivery from a wireless calling party terminal using a wireless communications network to a called party terminal, wherein the called party terminal has call waiting, the method comprising:
means for determining that the called party terminal's line is busy;
means for delivering a “call waiting no answer” message to the calling party terminal;
means for prompting the calling party to leave a message for the called party; and
means for storing the message from the calling party on the network.

18. The system defined in claim 17 further comprising means for delivering the message from the calling party terminal to the called party terminal when the called party terminal's line is no longer busy.

19. The system defined in claim 17 further comprising:
means for determining that an undelivered message awaits the called party after the called party terminal's line is no longer busy; and
means for retrieving the message from the calling party from the network.

20. The system defined in claim 17 further comprising a called party call pickup timer, wherein the means for delivering the “call waiting no answer” message delivers the “call waiting no answer” message after the call pickup timer expires.
